(19) United States
(12) Patent Application Publication
(10) Pub. No.: US 2011/0255459 A1
(43) Pub. Date: Oct. 20, 2011

(54) WIRELESS METROPOLITAN AREA NETWORK SERVICE OVER WIRELESS LOCAL AREA NETWORK

(76) Inventors: Vivek Gupta, San Jose, CA (US); Muthaiah Venkatachalam, Beaverton, OR (US)

(21) Appl. No.: 13/073,904

(22) Filed: Mar. 28, 2011

Related U.S. Application Data
(60) Provisional application No. 61/325,184, filed on Apr. 16, 2010.

(51) Int. Cl. H04W 4/00

(52) U.S. Cl. 370/312; 370/338

(57) ABSTRACT

Embodiments of the present disclosure describe methods, apparatuses, and systems for providing wireless metropolitan area network services over wireless local area networks.

### CROSS REFERENCE TO RELATED APPLICATIONS

The present application claims priority to U.S. Provisional Patent Application No. 61/325,184, titled “Advanced Wireless Communication Systems and Techniques,” filed Apr. 16, 2010. Said provisional application is hereby incorporated by reference in its entirety.

### FIELD

Embodiments of the present disclosure generally relate to the field of wireless communication systems, and more particularly, to providing wireless metropolitan area network services over a wireless local area network.

### BACKGROUND

Mobile devices are often provided a wireless connection through a wireless local area network (WLAN). Increasingly, a WLAN may, in turn, be connected to a wireless metropolitan area network (WMAN). Presently, WMAN services may not be available to a mobile device unless the mobile device is wirelessly connected directly to the WMAN.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a networking environment in accordance with some embodiments.

FIG. 2 is a call flow that may be performed to provide generic service access in accordance with some embodiments.

FIG. 3 schematically illustrates a networking environment in accordance with some embodiments.

FIG. 4 is a call flow that may be performed to provide generic service access in accordance with some embodiments.

FIG. 5 illustrates an example system capable of implementing a network device in accordance with some embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Embodiments of this disclosure describe a WLAN subscriber accessing generic services provided by a WMAN network. A WLAN, as used herein, can include, but is not limited to a network in which communications are conducted in accordance with an Institute for Electrical and Electronic Engineers (IEEE) 802.11 (e.g., 802.11-2009). A network and its constituent components configured to operate in accordance with an 802.11 standard may be referred to as a Wi-Fi network and/or component. A WMAN, as used herein, includes, but is not limited to, a network in which communications are conducted in accordance with an IEEE 802.16 standard (e.g., IEEE 802.16-2009). A network and its constituent components configured to operate in accordance with an IEEE 802.16 standard may be referred to as a WiMAX network and/or component.

Generic services provided by the WMAN network include, but are not limited to WMAN voice over Internet protocol (VoIP) services, e.g., WiMAX VoIP Services (WVS), location-based services (LBS), multicast broadcast-based services (MBS), machine-to-machine (M2M) services, etc. These services, which may hereinafter be collectively referred to as “generic WMAN services” or “generic services,” have heretofore been restricted to subscribers who connect to a WMAN connectivity service network (CSN) using a WMAN access service network (ASN).

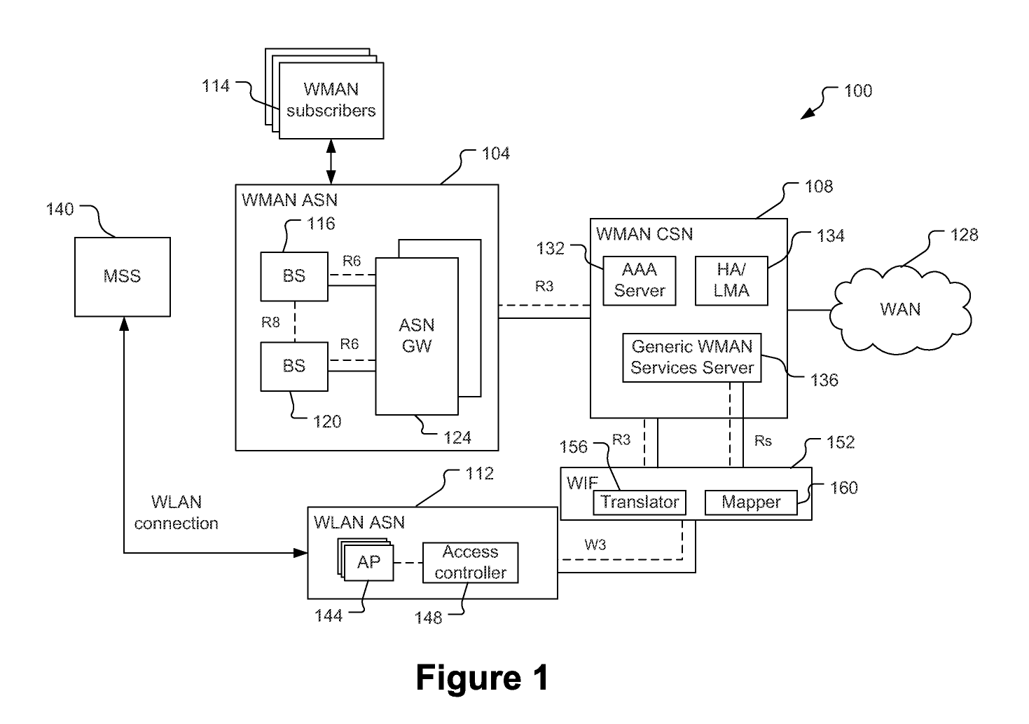

FIG. 1 schematically illustrates a networking environment 100 in accordance with some embodiments. The networking environment 100 may include components of both a WMAN and a WLAN. In particular, the networking environment 100 is shown with a WMAN ASN 104; a WMAN core service network (CSN) 108; and a WLAN ASN 112. In various embodiments, one service provider may deploy both the WLAN and the WMAN ASNs. In other embodiments, these ASNs may be provided by different service providers who have a contractual agreement between them that enables coordinated network access.

The networking environment 100 also shows a number of specific protocol interfaces between various components. These protocol interfaces, shown with an R# or W#, may refer to standardized WiMAX interfaces, also called “reference points,” that may describe various protocols and procedures that facilitate interoperability of WiMAX components. These protocol interfaces may be defined in a WiMAX Forum Network Working Group (NWG) specification, for example, WiMAX Forum NWG Release 1.6 or its successors.

The WMAN ASN 104 may provide broadband wireless radio access to WMAN subscribers 114. The WMAN ASN 104 may include one or more base stations, for example, base station (BS) 116 and BS 120, and one or more ASN gateways, for example, ASN gateway (GW) 124. BS 116 may be coupled with the BS 120 by an R8 interface. The R8 interface may be a control plane interface (represented by dotted line in FIG. 1) for communication of control information related to handovers between base stations. In some embodiments, the R8 interface may also include a data plane interface for communication of data involved in handovers. Each of the base stations may be coupled with the ASN GW 124 through respective R6 interfaces having both control and data plane interfaces (respectively represented by dotted and solid lines in FIG. 1). The ASN GW 124 may aggregate subscriber and control traffic from the base stations and communicate with the WMAN CSN 108 through an R3 interface having both control and data plane interfaces.

The WMAN CSN 108 may provide various IP connectivity functions to interconnect the WMAN ASN 104 with a wide area network (WAN) 128, e.g., an Internet. The WMAN CSN 108 may have an authentication server, e.g., authentication, authorization, and accounting (AAA) server 132, to implement one or more AAA protocols related to provision of networking services to subscribers and/or devices. The WMAN CSN 108 may also include a home agent (HA)/local mobility agent (LMA) 134 that operates as a routing anchor. The HA/LMA 134 may allow a subscriber to roam between various networks while still having secure access to a consistent set of capabilities. The WMAN CSN 108 may further include a generic WMAN services server 136. The generic WMAN services server 136 may provide subscriber access to generic WMAN services as discussed herein.

The networking environment 100 may also include a mobile subscriber station (MSS) 140. The MSS 140, which may also be referred to as a WLAN station or a WLAN client, may be communicatively coupled with an access point (AP) 144 of the WLAN ASN 112 through a WLAN connection. The WLAN ASN 112 may have an access controller 148 having a control plane interface with the AP 144.

The WLAN ASN 112 may be coupled with the WMAN CSN 108 through a WLAN internetworking function (WIF) 152. The WIF 152 may include a translator 156 to translate messages of a WLAN protocol into messages of a WMAN protocol, and vice versa. The WIF 152 may be coupled with the WLAN ASN 112 through a W3 interface having control and data plane interfaces. The WIF 152 may be coupled with the WMAN CSN 108 through an R3 interface and may further be coupled with the generic WMAN services server 136 through an Rs interface. Both the R3 and Rs interfaces may include control and data plane interfaces. In various embodiments, the WIF 152 may be included within a component of the WLAN ASN 112, included within a component of the WMAN CSN 108, or deployed in a component independent of the WLAN ASN 112 and the WMAN CSN 108.

The WIF 152 may access certain core services of the WMAN CSN 108 through the R3 interface. These core services, may be distinguished from generic services, and may include, for example, authentication/authorization services provided by the AAA server 132; anchoring services provided by the HA/LMA 134; dynamic host configuration protocol (DHCP) services for IP address configuration; and data path services that establish uplink and downlink bearer paths for access to the WAN 128.

The WIF 152 may access generic WMAN services through the Rs interface, which acts as a service specific interface. The WIF 152 may include a mapper 160 that maps the Rs interface to different protocol interfaces for specific generic services as specified, for example, by a WiMAX Forum NWG specification. For example, for WVS services, the mapper 160 may map the Rs interface to an R2-V interface; for LBS, the mapper 160 may map the Rs may map to an R3 interface; etc.

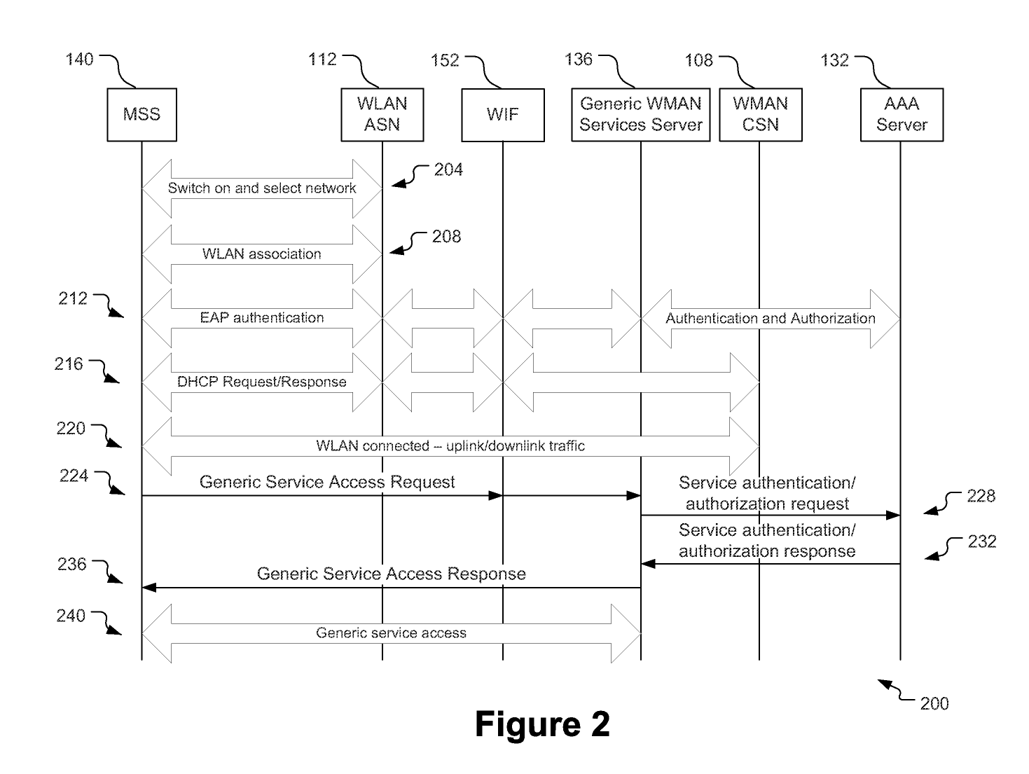

Provision of generic WMAN services to the MSS 140, for the networking environment 100, may be described by reference to call flow 200 shown in FIG. 2 in accordance with some embodiments. In exchange 204, the MSS 140 may switch on and select a WLAN network with which to connect, for example, WLAN ASN 112. In exchange 208, the MSS 140 may associate with the selected WLAN, e.g., WLAN ASN 112. In exchange 212, an extensible authentication protocol (EAP) authentication may be performed. The EAP authentication may occur through the relaying of identity and credential information from the MSS 140 to the AAA Server 132, with the translator 156 of the WIF 152 providing desired translations. The AAA server 132 may then perform the authentication and authorization to admit the MSS 140.

In various embodiments, the MSS 140 may use a common set of credentials, issued by the WMAN CSN, to access the WMAN CSN 108 through either WMAN ASN 104 or WLAN ASN 112. In other embodiments, the WLAN network may issue its own set of credentials just for accessing the WLAN ASN 112 and connecting to the WMAN CSN 108. Thus, in these embodiments, the MSS 140 may have two separate sets of credentials; one for accessing the WMAN ASN 104 and another for accessing the WLAN ASN 112.

Following authorization, at exchange 216, a DHCP request/response may be performed between the MSS 140 and the WMAN CSN 108 to obtain an IP address for the MSS 140 that may be used in communications over an IP network. In various embodiments, the WIF 152 may be used in the exchanges 212 and 216 to perform translations/functions desired for relevant internetwork communications.

Exchange 220 represents a successful WLAN connection, which provides a bearer path for uplink and downlink traffic through the WMAN CSN 108 by way of the WLAN ASN 112. Thus, exchanges 204, 208, 212, 216, and 220 may be performed to establish a WLAN connection.

Following establishment of the WLAN connection, the MSS 140 may transmit a generic service access request 224 to the generic WMAN services server 152. The generic service access request 224 may be encrypted using pre-shared keys (e.g., keys established by MSS 140 and generic WMAN services server 136 prior to exchange 212) or using keys established during normal authentication in, e.g., exchange 212. The generic service access request 224 may include an identification of one or more generic WMAN services requested by the MSS 140 as well as subscriber identification information (e.g., to identify user/mobile/device) and/or other access permissions and parameters specific to the requested services. The generic service access request 224 may be transmitted to the WLAN ASN 112 over the WLAN connection and then routed from the WLAN ASN 112 to the WIF 152 through the W3 interface. The generic service access request 224 may be translated from a WLAN protocol to a WMAN protocol by the translator 156 of the WIF 152 and further routed to the generic WMAN services server 136 through the Rs interface.

The generic WMAN services server 136 may generate a service authentication and authorization request 228, which may then be transmitted to the AAA server 132. The AAA server 132 may determine, based on the identity and credential information of the MSS 140, whether the MSS 140 is permitted to access the requested generic WMAN services, through the WLAN connection, and, upon determination, generate and transmit a service authentication and authorization response 232 to the generic WMAN services server 136. The generic WMAN services server 136 may, in turn, generate a generic service access response 236, which it transmits to the MSS 140, indicating that access to the requested generic WMAN services is either permitted or denied. In the event of access being permitted, the MSS 140 may be provided with generic service access represented by exchange 240.

The service authentication/authorization may include selected components, e.g., the MSS 140, the generic WMAN services server 136, and/or the AAA server 132, determining keys, pre-shared among the selected components, that are used in the encryption/decryption of the various requests/responses, e.g., generic service access request 224, service authentication/authorization request 228, service authentication/authorization response 232, and/or the generic service access response 236. The pre-shared keys may be determined by pre-provisioning or dynamic derivation.

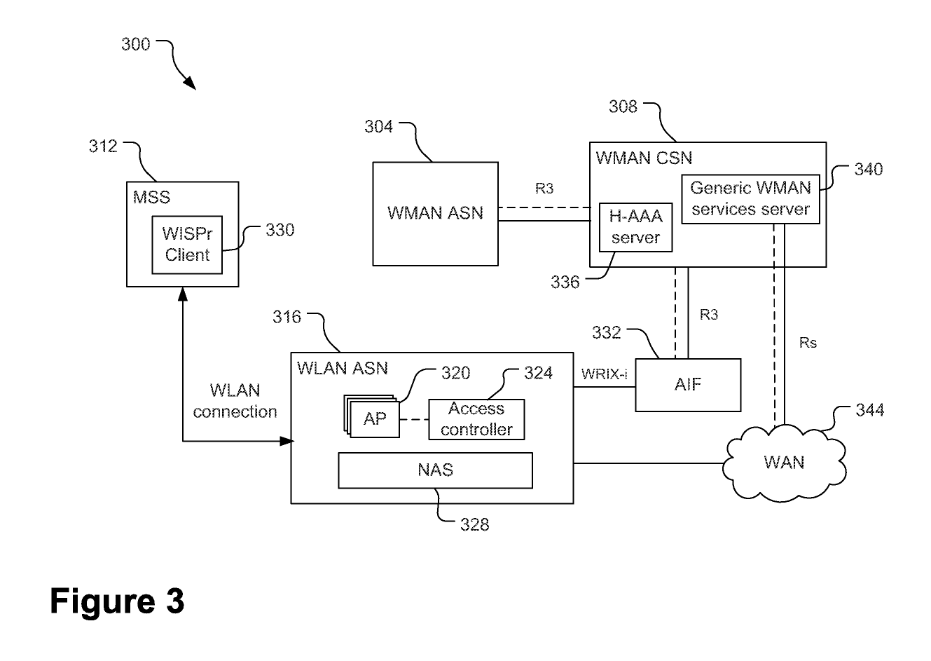

In an embodiment in which the pre-shared keys are pre-provisioned, the pre-provisioning may be done using an over the air (OTA) technique on the MSS 140 and the AAA server 132. The OTA technique of an embodiment may be a technique as defined by the Open Mobile Alliance (OMA) Device Management (DM) specification, version 1.2, as modified in April 2006. The AAA server 132 may pass the pre-shared keys to the generic WMAN services server 136. The MSS 140 may then be able to authenticate with the generic WMAN services server 136 using the pre-shared keys at runtime without having to rely on an internetworking capability of the WIF 152. This may occur, e.g., if the generic WMAN services server 136 is accessed directly through a roaming scenario, such as described below with respect to FIG. 3.

In an embodiment in which the pre-shared keys are derived dynamically the security aspects may be handled as follows. If the MSS 140 has already authenticated with the AAA server 132 then the pre-shared keys may be derived at runtime. Both the AAA server 132 and the MSS 140 may have the extended master session key (EMSK) and they may use this EMSK to compute the secondary set of pre-shared keys that may be used for service-level authentication/authorization. The AAA server 132 may pass this secondary set of pre-shared keys onto the generic WMAN services server 136. If the MSS 140 is currently not attached to the WMAN CSN 108, but trying to access a generic WMAN service over a WLAN connection, the EMSK of the last WMAN access may be used on both ends to derive the pre-shared keys for service authentication.

Various embodiments provide for access of generic WMAN services over a WLAN by a roaming mobile station. In such cases, the WLAN and WMAN service providers may have a roaming agreement with one another. FIG. 3 illustrates a communication environment 300 describing access to generic WMAN services in the roaming context in accordance with some embodiments.

The communication environment 300 may include a WMAN ASN 304 coupled with a WMAN CSN 308 by an R3 interface similar to that described above with respect to networking environment 100. The WMAN ASN 304 and the WMAN CSN 308 may be a home WMAN network for a MSS 312.

The MSS 312, when roaming, may be communicatively coupled with a visited WLAN ASN, e.g., WLAN ASN 316, by a WLAN connection. The WLAN ASN 316 may have an AP 320 and an access controller 324 that operate similar to the AP 144 and the access controller 148 discussed above with respect to FIG. 1. The WLAN ASN 316 may further include a network access server (NAS) 328 that operates as a wireless Internet service provider roaming (WISPr) portal to, in conjunction with a WISPr client 330 on the MSS 312, provide the MSS 312 network access on a roaming basis.

The WLAN ASN 316 may be coupled with an AAA internetworking function (AIF) component 332. The WLAN ASN 316 may communicate with the AIF 332 in accordance with a wireless roaming intermediary exchange (WRIX) remote authentication dial in user service (RADIUS) protocol over, e.g., an WRIX-i interface. The AIF 332 may be coupled with a home AAA server 336 of the WMAN CSN 308 by an R3 interface.

The WLAN ASN 316 may be coupled with a generic WMAN services server 340 of the WMAN CSN 308 over a WAN 344. The WAN 344 may be coupled with the home WMAN CSN 308 by an Rs interface.

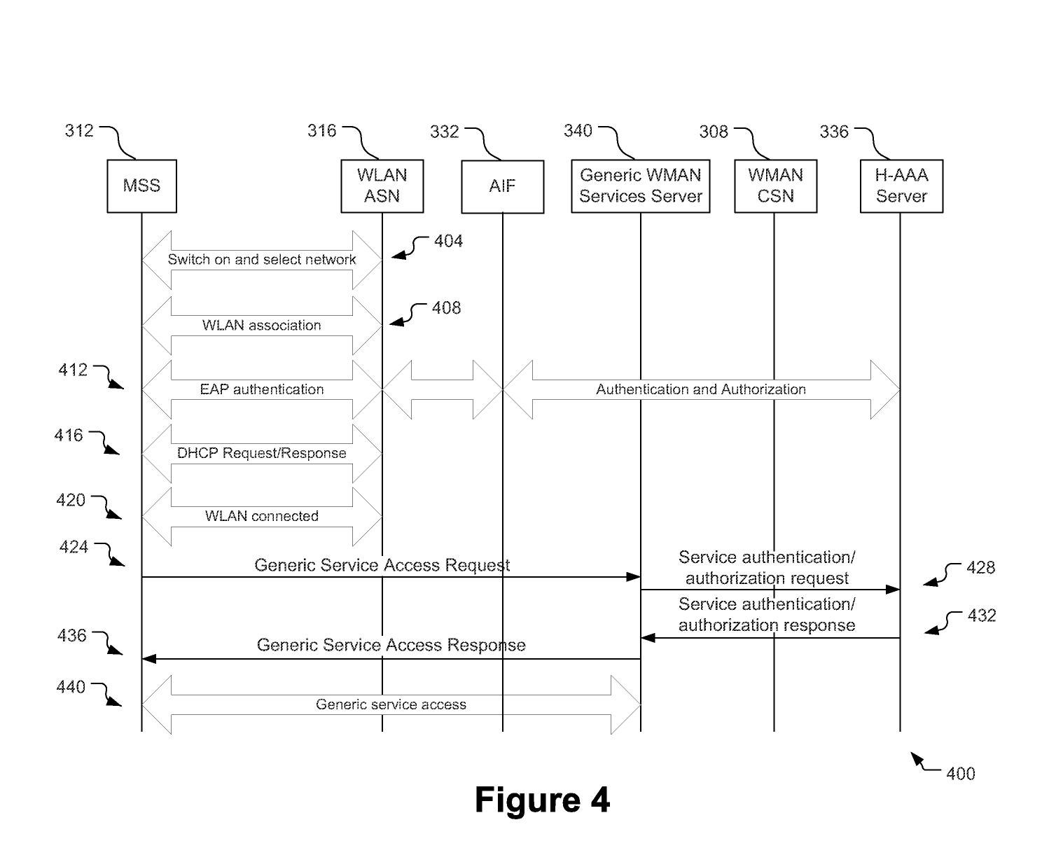

Provision of the generic WMAN services to the MSS 312, for the communication environment 300, may be described by reference to call flow 400 shown in FIG. 4 in accordance with some embodiments. In exchange 404, the MSS 312 may switch on and select a WLAN network with which to connect, for example, visited WLAN ASN 316. In exchange 408, the MSS 140 may associate with the selected WLAN, e.g., visited WLAN ASN 316. In exchange 412, an EAP authentication may be performed. The EAP authentication may occur by the AIF 332 translating identity and credential information and relaying the translated information to the H-AAA server 336. It may be noted that contrary to a WIF, which routes all requests to a WMAN CSN to which it is coupled, the AIF 332 may only map authentication requests across two networks. The H-AAA server 336 may then perform the authentication and authorization to admit the MSS 312.

Following authorization, at exchange 412, a DHCP request/response may be performed, at exchange 416, between the MSS 312 and the WLAN ASN 316 to obtain an IP address for the MSS 312 that may be used in communications over an IP network.

Exchange 420 represents a successful WLAN connection, which provides a bearer path for uplink and downlink traffic through the WLAN ASN 316. Thus, exchanges 404, 408, 412, and 416 may be performed to establish the WLAN connection represented by exchange 420.

Following establishment of the WLAN connection, the MSS 312 may discover an address of the generic WMAN services server using a domain name service (DNS)/fully qualified domain name (FQDN). Once the address is discovered, the MSS 312 may transmit a generic service access request 424 to the generic WMAN services server 340. The generic service access request 424 may include an identification of one or more generic WMAN services requested by the MSS 312. The generic service access request 424 may be transmitted to the WLAN ASN 316 over the WLAN connection and then routed through the WAN 344 prior to being delivered to the generic WMAN services server 340 through the Rs interface.

The generic WMAN services server 340 may generate a service authentication and authorization request 428, which may then be transmitted to the H-AAA server 336. The H-AAA server 336 may determine whether the MSS 312 is permitted to access to the requested generic WMAN services, through the WLAN connection, and, upon determination, generate and transmit a service authentication and authorization response 432 to the generic WMAN services server 340. The generic WMAN services server 340 may, in turn, generate a generic service access response 436, which it transmits to the MSS 312, indicating that access to the requested generic WMAN services is either permitted or denied. In the event of access being permitted, the MSS 312 may be provided with generic service access represented by exchange 440.

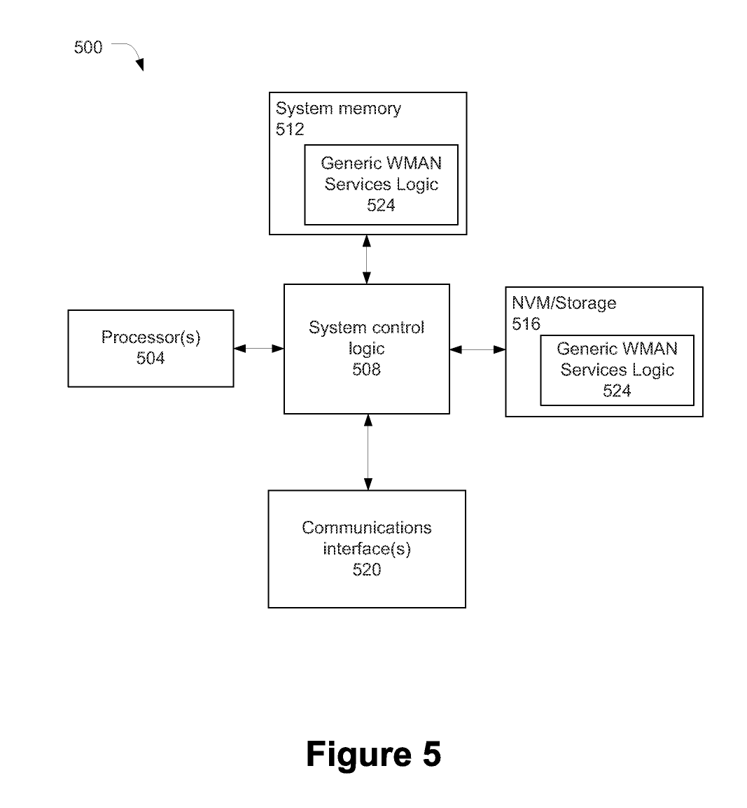

The network components described herein may be implemented into a system using any suitable hardware and/or software to configure as desired. FIG. 5 illustrates, for one embodiment, an example system 500 comprising one or more processor(s) 504, system control logic 508 coupled to at least one of the processor(s) 504, system memory 512 coupled to system control logic 508, non-volatile memory (NVM)/storage 516 coupled to system control logic 508, and one or more communications interface(s) 520 coupled to system control logic 508.

System control logic 508 for one embodiment may include any suitable interface controllers to provide for any suitable interface to at least one of the processor(s) 504 and/or to any suitable device or component in communication with system control logic 508.

System control logic 508 for one embodiment may include one or more memory controller(s) to provide an interface to system memory 512. System memory 512 may be used to load and store data and/or instructions, for example, for system 500. System memory 512 for one embodiment may include any suitable volatile memory, such as suitable dynamic random access memory (DRAM), for example.

System control logic 508 for one embodiment may include one or more input/output (I/O) controller(s) to provide an interface to NVM/storage 516 and communications interface(s) 520.

NVM/storage 516 may be used to store data and/or instructions, for example. NVM/storage 516 may include any suitable non-volatile memory, such as flash memory, for example, and/or may include any suitable non-volatile storage device(s), such as one or more hard disk drive(s) (HDD(s)), one or more compact disk (CD) drive(s), and/or one or more digital versatile disk (DVD) drive(s) for example.

The NVM/storage 516 may include a storage resource physically part of a device on which the system 500 is installed or it may be accessible by, but not necessarily a part of, the device. For example, the NVM/storage 516 may be accessed over a network via the communications interface(s) 520.

System memory 512 and NVM/storage 516 may include, in particular, temporal and persistent copies of generic WMAN services logic 524, respectively. The generic WMAN services logic 524 may include instructions that when executed by at least one of the processor(s) 504 result in the system 500 performing generic WMAN services operations that occur as a result of a mobile station requesting and/or accessing generic WMAN services over a WLAN connection as described above with respect to an MSS, WIF, or a generic WMAN services server. In some embodiments, the generic WMAN services logic 524 may additionally/alternatively be located in the system control logic 508.

Communications interface(s) 520 may provide an interface for system 500 to communicate over one or more network(s) and/or with any other suitable device. Communications interface(s) 520 may include any suitable hardware and/or firmware. Communications interface(s) 520 for one embodiment may include, for example, a network adapter, a wireless network adapter, a telephone modem, and/or a wireless modem. For wireless communications, communications interface(s) 520 for one embodiment may use one or more antennae.

For one embodiment, at least one of the processor(s) 504 may be packaged together with logic for one or more controller(s) of system control logic 508. For one embodiment, at least one of the processor(s) 504 may be packaged together with logic for one or more controllers of system control logic 508 to form a System in Package (SiP). For one embodiment, at least one of the processor(s) 504 may be integrated on the same die with logic for one or more controller(s) of system control logic 508. For one embodiment, at least one of the processor(s) 504 may be integrated on the same die with logic for one or more controller(s) of system control logic 508 to form a System on Chip (SoC).

In various embodiments, system 500 may have more or less components, and/or different architectures.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

What is claimed is:

1. A method comprising:
establishing, by a mobile subscriber station, a wireless connection with a wireless local area network (WLAN) access service network (ASN);
transmitting, by the mobile subscriber station, subsequent to the establishing of the wireless connection, a generic service access request to a server of a wireless metropolitan area network (WMAN) core service network (CSN), the generic service access request to request access to a generic service provided by the server; and
receiving, by the mobile station, a generic service access response from the server indicating enabled access to the service.

2. The method of claim 1, wherein the service is a WMAN voice over Internet protocol service, a location-based service, a multicast broadcast service, or a machine-to-machine service.

3. The method of claim 1, wherein the generic service access request includes an identification of the generic service, subscriber identification information, and a parameter specific to the generic service.

4. The method of claim 1, further comprising:
determining, by the mobile subscriber station, a key shared with the server through pre-provisioning or dynamic derivation; and
encrypting the generic service access request with the key.

5. The method of claim 4, wherein said determining comprises determining the key based on an extended master session key from a prior association with the WMAN CSN.

6. The method of claim 1, wherein said establishing the wireless connection comprises:
establishing the wireless connection with a network access server, of the WLAN ASN, that operates as a wireless Internet service provider roaming portal.

7. The method of claim 1, further comprising:
accessing the WMAN CSN through the WLAN ASN using a set of credentials issued by the WMAN CSN; and
accessing the WMAN CSN through a WMAN ASN using the set of credentials.

8. The method of claim 1, further comprising:
accessing the WMAN CSN through the WLAN ASN using a first set of credentials; and
accessing the WMAN CSN through a WMAN ASN using a second set of credentials.

9. An apparatus comprising:
a translator configured to facilitate provision of access, by a mobile subscriber station, to a service selected from a plurality of generic wireless metropolitan area network (WMAN) services, when the mobile subscriber station is communicatively coupled to the apparatus through a wireless local area network (WLAN) access service network (ASN); and
a mapper configured to map an interface to a protocol interface, based on the selected service, to provide the mobile subscriber station access to the selected service.

10. The apparatus of claim 9, wherein the selected service is WMAN voice over Internet protocol service (WVS) and the protocol interface is an R2-V interface.

11. The apparatus of claim 9, wherein the selected service is a location based service and the protocol interface is an R3 interface.

12. The apparatus of claim 9, wherein the translator is configured to facilitate provision of access by being configured to:
receive a generic service access request, that identifies the service, from the mobile subscriber station;
translate the generic service access request from a WLAN protocol to a WMAN protocol; and
transmit the generic service access request to a server that provides the plurality of generic WMAN services.

13. A non-transitory, computer-readable medium having associated instructions that, if executed, cause a server of a wireless metropolitan area network (WMAN) core services network (CSN) to:
receive a generic services access request from a mobile subscriber station through a wireless local area network (WLAN) access service network (ASN), the generic services access request requesting access to a service provided by the server;
determine that the mobile subscriber station is permitted to access the service; and
transmit a generic services access response to indicate permission to access the service based on said determination that the mobile subscriber station is permitted to access the service.

14. The non-transitory, computer-readable medium of claim 13, wherein the generic services access request includes identity and credential information associated with the mobile subscriber station and the associated instructions, if executed, further cause the server to:
transmit a service authentication and authorization request to an authentication server of the WMAN CSN;
receive a service authentication and authorization response, in response to the service authentication and authorization request, from the authentication server; and
determine that the mobile subscriber station is permitted to access the service based on the service and authentication and authorization response.

15. The non-transitory, computer-readable medium of claim 13, wherein the service is a WMAN voice over Internet protocol service, a location-based service, a multicast broadcast service, or a machine-to-machine service.

16. The non-transitory, computer-readable medium of claim 13, wherein the associated instructions, if executed, further cause the server to:
determine a key shared with the mobile subscriber station through pre-provisioning or dynamic derivation; and
decrypt the generic services access request based on the key.

17. A method comprising:
establishing, by one or more components of a wireless local area network (WLAN) access service network (ASN), a wireless connection with a mobile subscriber station;
receiving a generic service access request from the MSS after the establishing of the wireless connection;
transmitting the generic service access request to a generic wireless metropolitan access network (WMAN) services server;
receiving, in response to the generic service access request, a generic service access response from the generic WMAN services server; and
transmitting the generic service access response to the MSS.

18. The method of claim 17, further comprising:
transmitting both the generic service access request and one or more authentication requests to the WMAN CSN through a wireless internetworking function.

19. The method of claim 18, further comprising:
using a W3 interface to communicate with the wireless internetworking function.

20. The method of claim 17, further comprising:
transmitting the generic services access request to the WMAN CSN through a wide area network; and
transmitting one or more authentication requests to the WMAN CSN through an authentication, authorization, and accounting internetworking function.
